(19) United States
(12) Patent Application Publication
(10) Pub. No.: US 2016/0341961 A1
(43) Pub. Date: Nov. 24, 2016

(54) CONTEXT-BASED AUGMENTED REALITY CONTENT DELIVERY

(71) Applicant: DAQRI, LLC, Los Angeles, CA (US)

(72) Inventors: Brian Mullins, Altadena, CA (US); Matthew Kammerait, Studio City, CA (US)

(21) Appl. No.: 15/158,482

(22) Filed: May 18, 2016

Related U.S. Application Data
(60) Provisional application No. 62/163,037, filed on May 18, 2015.

(51) Int. Cl. G02B 27/01; G06F 3/01; G06T 19/00

(52) U.S. Cl. CPC G02B 27/017; G06T 19/006; G06F 3/015; G06F 3/012; G02B 2027/014

(57) ABSTRACT

A head mounted device (HMD) includes a transparent display, a first set of sensors, a second set of sensors, and a processor. The first set of sensors measures first sensor data related to a user of the HMD. The second set of sensors measures second sensor data related to the HMD. The processor determines a user-based context based on the first sensor data, determines an ambient-based context based on the second sensor data, and accesses AR content based on the user-based context and the ambient-based context. The HMD displays the AR content on the transparent display.

### REFERENCE TO RELATED APPLICATION

This application claims the benefit of priority of U.S. Provisional Application No. 62/163,037 filed May 18, 2015, which is herein incorporated by reference in its entirety.

### TECHNICAL FIELD

The subject matter disclosed herein generally relates to an augmented reality device. Specifically, the present disclosure addresses systems and methods for delivery of context-based augmented reality content.

### BACKGROUND

An augmented reality (AR) device can be used to generate and display data in addition to an image captured with the AR device. For example, AR is a live, direct, or indirect view of a physical, real-world environment whose elements are augmented by computer-generated sensory input such as sound, video, graphics or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

### BRIEF DESCRIPTION OF THE DRAWINGS

Some embodiments are illustrated by way of example and not limitation in the figures of the accompanying drawings.

FIG. 1 is a block diagram illustrating an example of a network suitable for a head mounted device system, according to some example embodiments.

FIG. 2 is a block diagram illustrating an example embodiment of a head mounted device (HMD).

FIG. 3 is a block diagram illustrating examples of sensors.

FIG. 4 is a block diagram illustrating an example embodiment of a context-based application.

FIG. 5 is a block diagram illustrating an example embodiment of a server.

FIG. 6 is a flowchart illustrating a method for delivering context-based augmented reality content, according to an example embodiment.

FIG. 7 is a flowchart illustrating a method for delivering context-based augmented reality content, according to another example embodiment.

FIG. 8 is a flowchart illustrating a method for delivering context-based augmented reality content, according to yet another example embodiment.

FIG. 9A is an interaction diagram illustrating interactions between a head mounted device and a server for context-based augmented reality content delivery, according to an example embodiment.

FIG. 9B is an interaction diagram illustrating interactions between a head mounted device and a server for context-based augmented reality content delivery, according to an example embodiment.

FIG. 10 is a block diagram illustrating an example of a library of context-based AR content, according to an example embodiment.

FIG. 11A is a block diagram illustrating a front view of a head mounted device, according to some example embodiments.

FIG. 11B is a block diagram illustrating a side view of the head mounted device of FIG. 11A.

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems are directed to context-based AR content delivery. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, a head mounted device (HMD) includes a helmet, a transparent display, sensors, an AR application and a context-based application implemented in one or more processors. The transparent display includes lenses that are disposed in front of the user's eyes to display AR content (e.g., virtual objects). The AR application renders the AR content for display in the transparent display of the HMD. The sensors may include a first set of sensors connected to the user of the HMD to generate user-based sensor data related a user of the HMD, and a second set of sensors inside the HMD to generate ambient-based sensor data related to the HMD.

The first set of sensors measures data related to the user. For example, the first set of sensors measures at least one of a heart rate, a blood pressure, brain activity, and biometric data related to the user to generate the user-based sensor data. Examples of the first set of sensors include a heart rate sensor, a sweat sensor, and a biometric sensor. The biometric sensor may include, for example, an ocular camera attached to the transparent display and directed towards the eyes of the user. In another example, the biometric sensor includes electroencephalogram (EEG)/electrocardiogram (ECG) sensors disposed inside a perimeter of the helmet so that the EEG/ECG sensors connect to the forehead of the user when the helmet is worn. The biometric sensor generates biometric data based on, for example, the blood vessel pattern in the retina of an eye of the user, the structure pattern of the iris of an eye of the user, the brain wave pattern of the user, or a combination thereof. The processor authenticates the user based on the biometric data of the user of the HMD.

The second set of sensors measures at least one of a geographic location of the HMD, an orientation and position of the HMD, an ambient pressure, an ambient humidity level, and an ambient light level to generate the ambient-based sensor data. Examples of the second set of sensors include a camera, GPS sensor, an Inertial Measurement Unit (IMU), a location sensor, an audio sensor, a barometer, a humidity sensor, and an ambient light sensor.

The context-based application determines a user-based context based on the user-based sensor data, and an ambient-based context based on the ambient-based sensor data. The user-based context identifies the user of the HMD (e.g., user is John, employee 123, senior technician), a state of mind of the user (e.g., John is distracted), and a physical state of the user (e.g., John is sweating and breathing heavily while staring at machine M). The ambient-based context identifies data related to a state of the HMD. For example, the ambient-based context identifies ambient data related to the location of the HMD. For example, the ambient data may identify a geographic location (e.g., HMD located at factory plant P), an elevation (e.g., HMD is located on the 3^{rd} floor of the factory plant P), ambient pressure (e.g., atmospheric pressure in a room where the HMD is located), ambient humidity level (e.g., HMD is located in a room with humidity level of 60%), ambient light level (e.g., ambient brightness of 200 lumen detected by the HMD), ambient noise level (e.g., noise level of 90 db detected by the HMD).

The context-based application accesses AR content based on at least one of the user-based context and the ambient-based context. For example, AR content comprising instructions on how to fix machine M may be associated with user-based context C1 (e.g., John is sweating heavily and heart rate is above a threshold), and ambient-based context C2 (e.g., HMD worn by John is located on the second floor of factory plant P, in front of machine M, and the ambient noise level exceeds a siren noise level).

In another example embodiment, the context-based application identifies a physical object in an image generated by a camera of the HMD. The physical object is in a line of sight of the user through the transparent display (e.g., the user of the HMD is looking at the physical object through the transparent display). The context-based application accesses the AR content based on an identification of the physical object (e.g., a three-dimensional model of virtual nuts and bolts related to a physical valve is displayed in the transparent display so as to appear to the user as floating about the physical valve).

In another example embodiment, the context-based application compares the user-based sensor data with reference user-based sensor data and determines the user-based context data based on the comparison of the user-based sensor data with the reference user-based sensor data. The reference user-based sensor data may be preconfigured to associate a range of user-based sensor data with a corresponding AR content (e.g., a virtual dialog box appears in the transparent display when the user-based sensor data is within a range of the reference user-based sensor data). For example, the reference user-based sensor data comprises a set of physiological data ranges for the user corresponding to the first set of sensors.

In another example embodiment, the context-based application compares the ambient-based sensor data with reference ambient-based sensor data and determines the ambient-based context data based on the comparison of the ambient-based sensor data with the reference ambient-based sensor data. The reference ambient-based sensor data may be preconfigured to associate a range of ambient-based sensor data with a corresponding AR content (e.g., a virtual arrow appears in the transparent display when the ambient-based sensor data is within a range of the reference ambient-based sensor data). For example, the reference ambient-based sensor data comprises a set of ambient data ranges for the HMD corresponding to the second set of sensors.

In another example embodiment, a first AR content is associated with a first set of physiological data ranges for the user of the HMD and a first set of ambient data ranges for the HMD. A second AR content is associated with a second set of physiological data ranges for the user of the HMD and a second set of ambient data ranges for the HMD.

In another example embodiment, a first AR application is associated with a first set of physiological data ranges for the user of the HMD and a first set of ambient data ranges for the HMD. A second AR application is associated with a second set of physiological data ranges for the user of the HMD and a second set of ambient data ranges for the HMD. The context-based application can also receive ambient-based sensor data from a third set of sensors external to the HMD. In that case, the context-based application determines the ambient-based context based on the ambient-based sensor data from the second and third set of sensors.

In another example embodiment, the HMD includes the AR application that identifies an object in an image captured with the camera, retrieves a three-dimensional model of a virtual object from the augmented reality content based on the identified object, and renders the three-dimensional model of the virtual object in the transparent display lens. The virtual object is perceived as an overlay on the real world object.

The display surface of the HMD may be retracted inside the helmet and extended outside the helmet to allow a user to view the display surface. The position of the display surface may be adjusted based on an eye level of the user. The display surface includes a display lens capable of displaying AR content. The helmet may include a computing device such as a hardware processor with an AR application that allows the user wearing the helmet to experience information, such as in the form of a virtual object such as a three-dimensional (3D) virtual object, overlaid on an image or a view of a physical object (e.g., a gauge) captured with a camera in the helmet. The helmet may include optical sensors. The physical object may include a visual reference (e.g., a recognized image, pattern, or object, or unknown objects) that the AR application can identify using predefined objects or machine vision. A visualization of the additional information (also referred to as AR content), such as the 3D virtual object overlaid or engaged with a view or an image of the physical object, is generated in the display lens of the helmet. The display lens may be transparent to allow the user see through the display lens. The display lens may be part of a visor or face shield of the helmet or may operate independently from the visor of the helmet. The 3D virtual object may be selected based on the recognized visual reference or captured image of the physical object. A rendering of the visualization of the 3D virtual object may be based on a position of the display relative to the visual reference. Other AR applications allow the user to experience visualization of the additional information overlaid on top of a view or an image of any object in the real physical world. The virtual object may include a 3D virtual object and/or a two-dimensional (2D) virtual object. For example, the 3D virtual object may include a 3D view of an engine part or an animation. The 2D virtual object may include a 2D view of a dialog box, menu, or written information such as statistics information for properties or physical characteristics of the corresponding physical object (e.g., temperature, mass, velocity, tension, stress). The AR content (e.g., image of the virtual object, virtual menu) may be rendered at the helmet or at a server in communication with the helmet. In one example embodiment, the user of the helmet may navigate the AR content using audio and visual inputs captured at the helmet or other inputs from other devices, such as a wearable device. For example, the display lenses may extract or retract based on a voice command of the user, a gesture of the user, a position of a watch in communication with the helmet.

In another example embodiment, a non-transitory machine-readable storage device may store a set of instructions that, when executed by at least one processor, causes the at least one processor to perform the method operations discussed within the present disclosure.

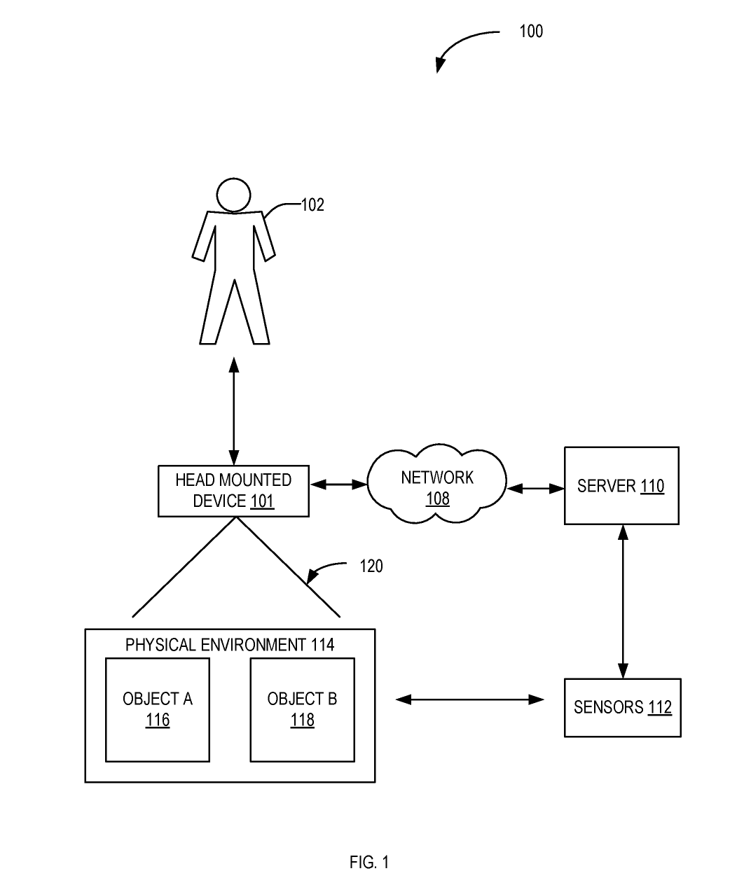

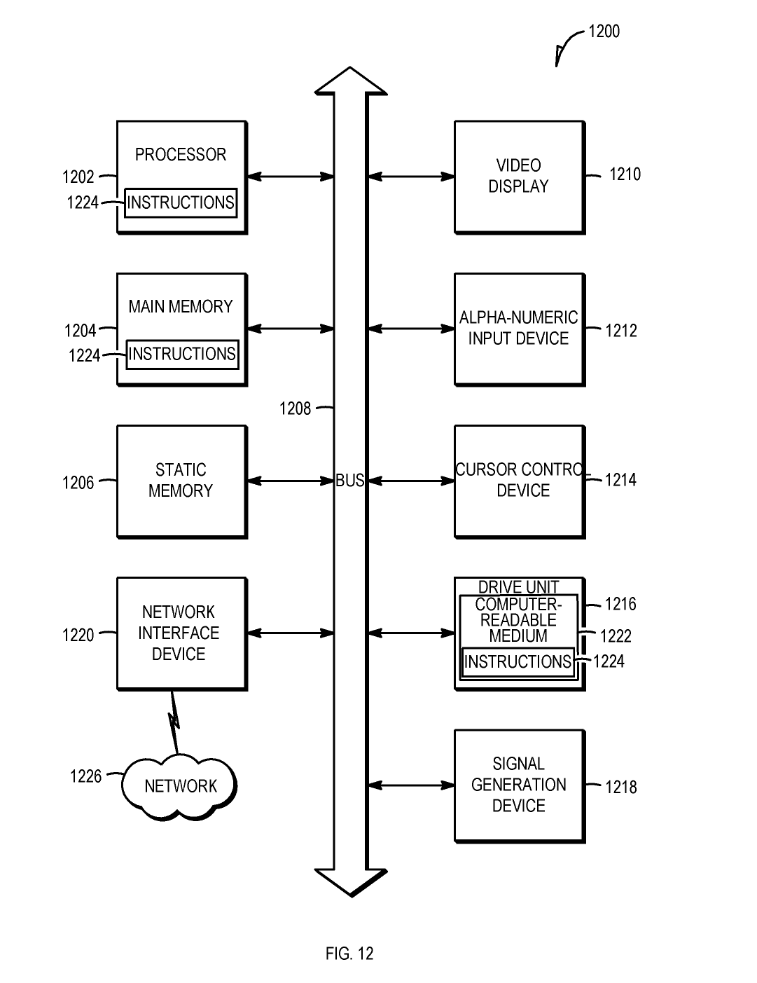

FIG. 1 is a network diagram illustrating a network environment 100 suitable for operating an AR application of a HMD with display lenses, according to some example embodiments. The network environment 100 includes a HMD 101 and a server 110, communicatively coupled to each other via a network 108. The HMD 101 and the server 110 may each be implemented in a computer system, in whole or in part, as described below with respect to FIG. 12.

The server 110 may be part of a network-based system. For example, the network-based system may be or include a cloud-based server system that provides AR content (e.g., augmented information including 3D models of virtual objects related to physical objects in images captured by the HMD 101) to the HMD 101.

The HMD 101 may include a helmet that a user 102 may wear to view the AR content related to captured images of several physical objects (e.g., object A 116, object B 118) in a real world physical environment 114. In one example embodiment, the HMD 101 includes a computing device with a camera and a display (e.g., smart glasses, smart helmet, smart visor, smart face shield, smart contact lenses). The computing device may be removably mounted to the head of the user 102. In one example, the display may be a screen that displays what is captured with a camera of the HMD 101. In another example, the display of the HMD 101 may be a transparent display, such as in the visor or face shield of a helmet, or a display lens distinct from the visor or face shield of the helmet.

The user 102 may be a user of an AR application in the HMD 101 and at the server 110. The user 102 may be a human user (e.g., a human being), a machine user (e.g., a computer configured by a software program to interact with the HMD 101), or any suitable combination thereof (e.g., a human assisted by a machine or a machine supervised by a human). The user 102 is not part of the network environment 100, but is associated with the HMD 101.

In one example embodiment, the AR application determines the AR content to be rendered and displayed in the transparent lenses of the HMD 101 based on sensor data related to the user 102 and sensor data related to the HMD 101. The sensor data related to the user 102 may include measurements of a heart rate, a blood pressure, brain activity, and biometric data related to the user. The sensor data related to the HMD 101 may include a geographic location of the HMD 101, an orientation and position of the HMD 101, an ambient pressure, an ambient humidity level, an ambient light level, and an ambient noise level detected by sensors in the HMD 101. The sensor data related to the user 102 may also be referred to as user-based sensor data. The sensor data related to the HMD 101 may be also referred to as ambient-based sensor data. For example, the HMD 101 may display a first AR content when the user 102 wearing the HMD 101 is on the first floor of a building. The HMD 101 may display a second AR content, different from the first AR content, when the user 102 is on the second floor of the building. In another example, the HMD 101 may display an AR content when the user 102 is alert and located in front of machine M1. The HMD 101 may display a different AR content when the user 102 is nervous or sleepy and is located in the same machine M1. In another example, the HMD 101 provides a first AR application (e.g., showing schematic diagrams of a building) when the user 102 is identified as a firefighter and is located on the first floor of a building. The HMD 101 may provide a second AR application (e.g., showing location of non-functioning sprinklers) when the user 102 is identified as a firefighter and sensors in the building indicate temperature exceeding a threshold (e.g., fire in the building). Therefore, different AR content and different AR applications may be provided to the HMD 101 based on a combination of the user-based sensor data and the ambient-based sensor data.

In another example embodiment, the AR application may provide the user 102 with an AR experience triggered by identified objects in the physical environment 114. The physical environment 114 may include identifiable objects such as a 2D physical object (e.g., a picture), a 3D physical object (e.g., a factory machine), a location (e.g., at the bottom floor of a factory), or any references (e.g., perceived corners of walls or furniture) in the real world physical environment 114. The AR application may include computer vision recognition to determine corners, objects, lines, and letters. The user 102 may point a camera of the HMD 101 to capture an image of the objects A 116 and B 118 in the physical environment 114.

In one example embodiment, the objects A 116, B 118 in the image are tracked and recognized locally in the HMD 101 using a local context recognition dataset or any other previously stored dataset of the AR application of the HMD 101. The local context recognition dataset module may include a library of virtual objects associated with real-world physical objects A 116, B 118 or references. In one example, the HMD 101 identifies feature points in an image of the objects A 116, B 118 to determine different planes (e.g., edges, corners, surface, dial, letters). The HMD 101 may also identify tracking data related to the objects A 116, B 118 (e.g., GPS location of the HMD 101, orientation, distances to objects A 116, B 118). If the captured image is not recognized locally at the HMD 101, the HMD 101 can download additional information (e.g., 3D model or other augmented data) corresponding to the captured image, from a database of the server 110 over the network 108.

In another embodiment, the objects A 116, B 118 in the image are tracked and recognized remotely at the server 110 using a remote context recognition dataset or any other previously stored dataset of an AR application in the server 110. The remote context recognition dataset module may include a library of virtual objects or augmented information associated with real-world physical objects A 116, B 118 or references.

Sensors 112 may be associated with, coupled to, or related to the objects A 116 and B 118 in the physical environment 114 to measure a location, information, or captured readings from the objects A 116 and B 118. Examples of captured readings may include, but are not limited to, weight, pressure, temperature, velocity, direction, position, intrinsic and extrinsic properties, acceleration, and dimensions. For example, sensors 112 may be disposed throughout a factory floor to measure movement, pressure, orientation, and temperature. The server 110 can compute readings from data generated by the sensors 112. The server 110 can generate virtual indicators such as vectors or colors based on data from sensors 112. Virtual indicators are then overlaid on top of a live image of objects A 116 and B 118 to show data related to the objects A 116 and B 118. For example, the virtual indicators may include arrows with shapes and colors that change based on real-time data. The visualization may be provided to the HMD 101 so that the HMD 101 can render the virtual indicators in a display of the HMD 101. In another embodiment, the virtual indicators are rendered at the server 110 and streamed to the HMD 101. The HMD 101 displays the virtual indicators or visualization corresponding to a display of the physical environment 114 (e.g., data is visually perceived as displayed adjacent to the objects A 116 and B 118).

The sensors 112 may include other sensors used to track the location, movement, and orientation of the HMD 101 externally without having to rely on the sensors 112 internal to the HMD 101. The sensors 112 may include optical sensors (e.g., depth-enabled 3D camera), wireless sensors (Bluetooth, Wi-Fi), GPS sensor, and audio sensors to determine the location of the user 102 having the HMD 101, a distance of the user 102 to the tracking sensors 112 in the physical environment 114 (e.g., sensors 112 placed in corners of a venue or a room), the orientation of the HMD 101 to track what the user 102 is looking at (e.g., direction at which the HMD 101 is pointed, HMD 101 pointed towards a player on a tennis court, HMD 101 pointed at a person in a room).

In another embodiment, data from the sensors 112 and internal sensors in the HMD 101 may be used for analytics data processing at the server 110 (or another server) for analysis on usage and how the user 102 is interacting with the physical environment 114. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 moved with the HMD 101 when looking at the physical or virtual object, which features of the virtual object the user 102 interacted with (e.g., such as whether a user 102 tapped on a link in the virtual object), and any suitable combination thereof. The HMD 101 receives a visualization content dataset related to the analytics data. The HMD 101 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., HMD 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

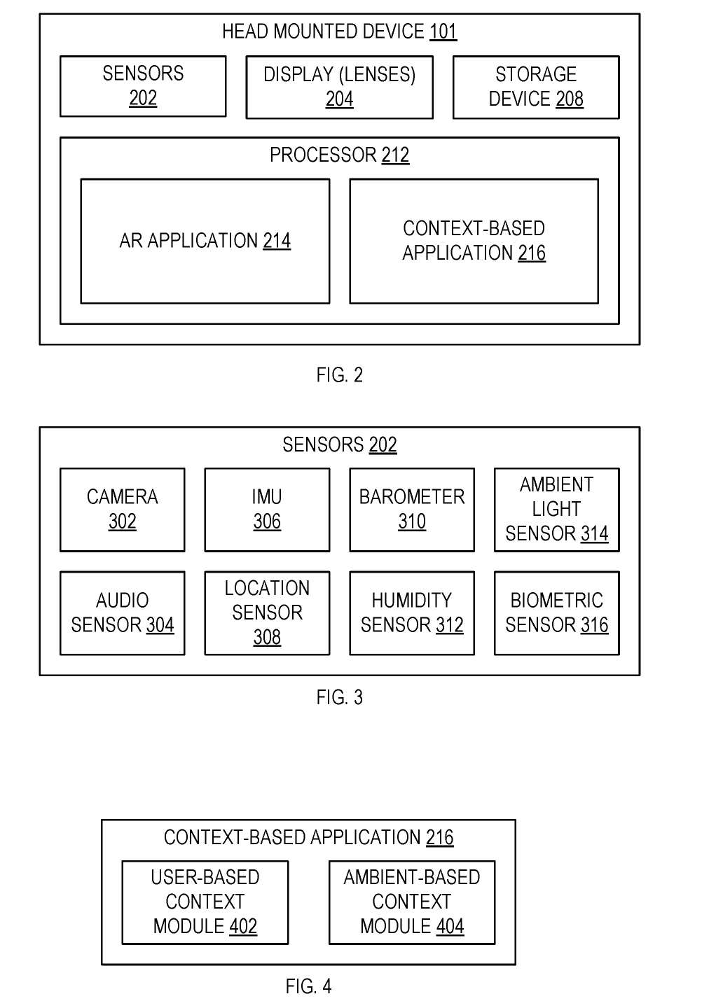

FIG. 2 is a block diagram illustrating modules (e.g., components) of the HMD 101, according to some example embodiments. The HMD 101 may be a helmet that includes sensors 202, a display 204, a storage device 208, and a processor 212. The HMD 101 may not be limited to a helmet and may include any type of device that can be worn on the head of a user, e.g., user 102, such as a headband, a hat, or a visor.

The sensors 202 may be used to generate internal tracking data of the HMD 101 to determine a position and an orientation of the HMD 101. The position and the orientation of the HMD 101 may be used to identify real world objects in a field of view of the HMD 101. For example, a virtual object may be rendered and displayed in the display 204 when the sensors 202 indicate that the HMD 101 is oriented towards a real world object (e.g., when the user 102 looks at object A 116) or in a particular direction (e.g., when the user 102 tilts his head to watch his wrist). The HMD 101 may display a virtual object also based on a geographic location of the HMD 101. For example, a set of virtual objects may be accessible when the user 102 of the HMD 101 is located in a particular building. In another example, virtual objects including sensitive material may be accessible when the user 102 of the HMD 101 is located within a predefined area associated with the sensitive material and the user is authenticated. Different levels of content of the virtual objects may be accessible based on a credential level of the user. For example, a user who is an executive of a company may have access to more information or content in the virtual objects than a manager at the same company. The sensors 202 may be used to authenticate the user prior to providing the user with access to the sensitive material (e.g., information displayed as a virtual object such as a virtual dialog box in a see-through display). Authentication may be achieved via a variety of methods such as providing a password or an authentication token, or using sensors 202 to determine biometric data unique to the user.

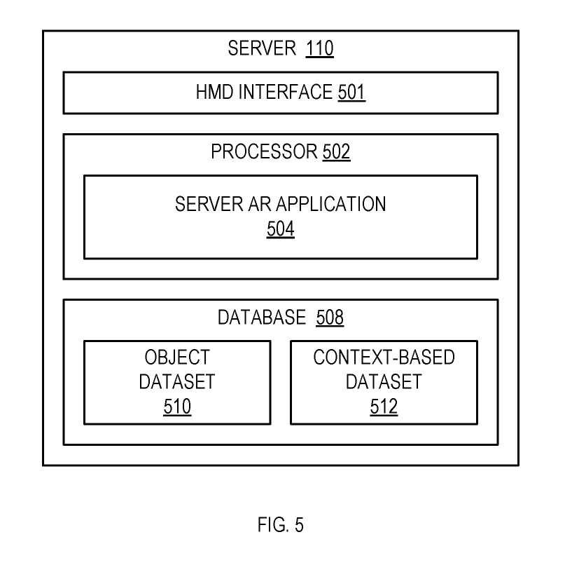

FIG. 3 is a block diagram illustrating examples of sensors 202 in HMD 101. For example, the sensors 202 may include a camera 302, an audio sensor 304, an IMU sensor 306, a location sensor 308, a barometer 310, a humidity sensor 312, an ambient light sensor 314, and a biometric sensor 316. It is noted that the sensors 202 described herein are for illustration purposes. Sensors 202 are thus not limited to the ones described.

The camera 302 includes an optical sensor(s) (e.g., camera) that may encompass different spectrums. The camera 302 may include one or more external cameras aimed outside the HMD 101. For example, the external camera may include an infrared camera or a full-spectrum camera. The external camera may include a rear-facing camera and a front-facing camera disposed in the HMD 101. The front-facing camera may be used to capture a front field of view of the HMD 101 while the rear-facing camera may be used to capture a rear field of view of the HMD 101. The pictures captured with the front- and rear-facing cameras may be combined to recreate a 360-degree view of the physical world around the HMD 101.

The camera 302 may include one or more internal cameras aimed at the user 102. The internal camera may include an infrared (IR) camera configured to capture an image of a retina of the user 102. The IR camera may be used to perform a retinal scan to map unique patterns of the retina of the user 102. Blood vessels within the retina absorb light more readily than the surrounding tissue in the retina and therefore can be identified with IR lighting. The IR camera may cast a beam of IR light into the user's eye as the user 102 looks through the display 204 (e.g., lenses) towards virtual objects rendered in the display 204. The beam of IR light traces a path on the retina of the user 102. Because retinal blood vessels absorb more of the IR light than the rest of the eye, the amount of reflection varies during the retinal scan. The pattern of variations may be used as a biometric data unique to the user 102.

In another example embodiment, the internal camera may include an ocular camera configured to capture an image of an iris of the eye of the user 102. In response to the amount of light entering the eye, muscles attached to the iris expand or contract the aperture at the center of the iris, known as the pupil. The expansion and contraction of the pupil depends on the amount of ambient light. The ocular camera may use iris recognition as a method for biometric identification. The complex pattern on the iris of the eye of the user 102 is unique and can be used to identify the user 102. The ocular camera may cast infrared light to acquire images of detailed structures of the iris of the eye of the user 102. Biometric algorithms may be applied to the image of the detailed structures of the iris to identify the user 102.

In another example embodiment, the ocular camera includes an IR pupil dimension sensor that is pointed at an eye of the user 102 to measure the size of the pupil of the user 102. The IR pupil dimension sensor may sample the size of the pupil (e.g., using an IR camera) on a periodic basis or based on predefined triggered events (e.g., the user 102 walks into a different room, or there are sudden changes in the ambient light, or the like).

The audio sensor 304 may include a microphone. For example, the microphone may be used to record a voice command from the user 102 of the HMD 101. In other examples, the microphone may be used to measure ambient noise level to determine an intensity of background noise ambient to the HMD 101. In another example, the microphone may be used to capture ambient noise. Analytics may be applied to the captured ambient noise to identify specific types of noises such as explosions or gunshot noises.

The IMU sensor 306 may include a gyroscope and an inertial motion sensor to determine an orientation and movement of the HMD 101. For example, the IMU sensor 306 may measure the velocity, orientation, and gravitational forces on the HMD 101. The IMU sensor 306 may also detect a rate of acceleration using an accelerometer and changes in angular rotation using a gyroscope.

The location sensor 308 may determine a geolocation of the HMD 101 using a variety of techniques such as near field communication, GPS, Bluetooth, and Wi-Fi. For example, the location sensor 308 may generate geographic coordinates of the HMD 101.

The barometer 310 may measure atmospheric pressure differential to determine an altitude of the HMD 101. For example, the barometer 310 may be used to determine whether the HMD 101 is located on a first floor or a second floor of a building.

The humidity sensor 312 may determine a relative humidity level ambient to the HMD 101. For example, the humidity sensor 312 determines the humidity level of a room in which the HMD 101 is located.

The ambient light sensor 314 may determine an ambient light intensity around the HMD 101. For example, the ambient light sensor 314 measures the ambient light in a room in which the HMD 101 is located.

The biometric sensor 316 include sensors configured to measure biometric data unique to the user 102 of the HMD 101. In one example embodiment, the biometric sensors 316 includes an ocular camera, an EEG (electroencephalogram) sensor, and an ECG (electrocardiogram) sensor. It is noted that the descriptions of biometric sensors 316 disclosed herein are for illustration purposes. The biometric sensor 316 is thus not limited to any of the ones described.

The EEG sensor includes, for example, electrodes that, when in contact with the skin of the head of the user 102, measure electrical activity of the brain of the user 102. The EEG sensor may also measure the electrical activity and wave patterns through different bands of frequency (e.g., Delta, Theta, Alpha, Beta, Gamma, Mu). EEG signals may be used to authenticate a user based on fluctuation patterns unique to the user.

The ECG sensor includes, for example, electrodes that measure a heart rate of the user 102. In particular, the ECG may monitor and measure the cardiac rhythm of the user 102. A biometric algorithm is applied to the user 102 to identify and authenticate the user. In one example embodiment, the EEG sensor and ECG sensor may be combined into a same set of electrodes to measure both brain electrical activity and heart rate. The set of electrodes may be disposed around the helmet so that the set of electrodes comes into contact with the skin of the user 102 when the user 102 wears the HMD 101.

Referring back to FIG. 2, the display 204 may include a display surface or lens capable of displaying AR content (e.g., images, video) generated by the processor 212. The display 204 may be transparent so that the user 102 can see through the display 204 (e.g., such as in a head-up display).

The storage device 208 stores a library of AR content, reference ambient-based context, reference user-based context, reference objects. The AR content may include two or three-dimensional models of virtual objects with corresponding audio. In other examples, the AR content may include an AR application that includes interactive features such as displaying additional data (e.g., location of sprinklers) in response to the user input (e.g., a user says “show me the locations of the sprinklers” while looking at an AR overlay showing location of the exit doors). AR applications may have their own different functionalities and operations. Therefore, each AR application may operate distinctly from other AR applications.

The ambient-based context may identify ambient-based attributes associated with a corresponding AR content or application. For example, the ambient-based context may identify a predefined location, a humidity level range, a temperature range for the corresponding AR content. Therefore, ambient-based context “AC1” is identified and triggered when the HMD 101 is located at the predefined location, when the HMD 101 detects a humidity level within the humidity level range, and when the HMD detects a temperature within the temperature range.

The reference user-based context may identify user-based attributes associated with the corresponding AR content or application. For example, the user-based context may identify a state of mind of the user, physiological aspects of the user, reference biometric data, a user identification, and user privilege level. For example, user-based context “UC1” is identified and triggered when the HMD 101 detects that the user (e.g., user 102) is focused, not sweating, and is identified as a technician. The state of mind of the user 102 may be measured with EEG/ECG sensors connected to the user 102 to determine a level of attention of the user 102 (e.g., distracted or focused). The physiological aspects of the user 102 may include biometric data that was previously captured and associated with the user 102 during a configuration process. The reference biometric data may include a unique identifier based on the biometric data of the user 102. The user identification may include the name and tile of the user 102 (e.g., John Doe, VP of engineering). The user privilege level may identify which content the user 102 may have access to (e.g., access level 5 means that the user 102 may have access to content in virtual objects that are tagged with level 5). Other tags or metadata may be used to identify the user privilege level (e.g., “classified”, “top secret”, “public”).

The storage device 208 may also store a database of identifiers of wearable devices capable of communicating with the HMD 101. In another embodiment, the database may also identify reference objects (visual references or images of objects) and corresponding experiences (e.g., 3D virtual objects, interactive features of the 3D virtual objects). The database may include a primary content dataset, a contextual content dataset, and a visualization content dataset. The primary content dataset includes, for example, a first set of images and corresponding experiences (e.g., interaction with 3D virtual object models). For example, an image may be associated with one or more virtual object models. The primary content dataset may include a core set of images or the most popular images determined by the server 110. The core set of images may include a limited number of images identified by the server 110. For example, the core set of images may include the images depicting covers of the ten most viewed devices and their corresponding experiences (e.g., virtual objects that represent the ten most sensing devices in a factory floor). In another example, the server 110 may generate the first set of images based on the most popular or often scanned images received at the server 110. Thus, the primary content dataset does not depend on objects A 116, B 118 or images scanned by the HMD 101.

The contextual content dataset includes, for example, a second set of images and corresponding experiences (e.g., three-dimensional virtual object models) retrieved from the server 110. For example, images captured with the HMD 101 that are not recognized (e.g., by the server 110) in the primary content dataset are submitted to the server 110 for recognition. If the captured image is recognized by the server 110, a corresponding experience may be downloaded at the HMD 101 and stored in the contextual content dataset. Thus, the contextual content dataset relies on the contexts in which the HMD 101 has been used. As such, the contextual content dataset depends on objects or images scanned by the AR application 214 of the HMD 101.

In one example embodiment, the HMD 101 may communicate over the network 108 with the server 110 to access a database of ambient-based context, user-based content context, reference objects, and corresponding AR content at the server 110. The HMD 101 then compares the ambient-based sensor data with attributes from the ambient-based context, and the ambient-based sensor data with attributes from the user-based context. The HMD 101 may also communicate with the server 110 to authenticate the user 102. In another example embodiment, the HMD 101 retrieves a portion of a database of visual references, corresponding 3D virtual objects, and corresponding interactive features of the 3D virtual objects.

The processor 212 may include an AR application 214 and a context-based application 216. The AR application 214 generates a display of information related to the objects A 116, B 118. In one example embodiment, the AR application 214 generates a visualization of information related to the objects A 116, B 118 when the HMD 101 captures an image of the objects A 116, B 118 and recognizes the objects A 116, B 118 or when the HMD 101 is in proximity to the objects A 116, B 118. For example, the AR application 214 generates a display of a holographic or virtual menu visually perceived as a layer on the objects A 116, B 118.

The context-based application 216 may determine ambient-based context related to the HMD 101 and user-based context related to the user 102 and provide AR content based on a combination of the ambient-based context, the user-based context, and the identification of object A 116. For example, the context-based application 216 provides a first AR content to the AR application 214 to display the first AR content in the display 204 based a first combination of ambient-based context, user-based context, and object identification. The context-based application 216 provides a second AR content to the AR application 214 to display the second AR content in the display 204 based a second combination of ambient-based context, user-based context, and object A 116 identification.

In another example embodiment, the context-based application 216 provides a first AR application to the AR application 214 based on a first combination of ambient-based context, user-based context, and object A 116 identification. The context-based application 216 provides a second AR application to the AR application 214 based on a second combination of ambient-based context, user-based context, and object identification.

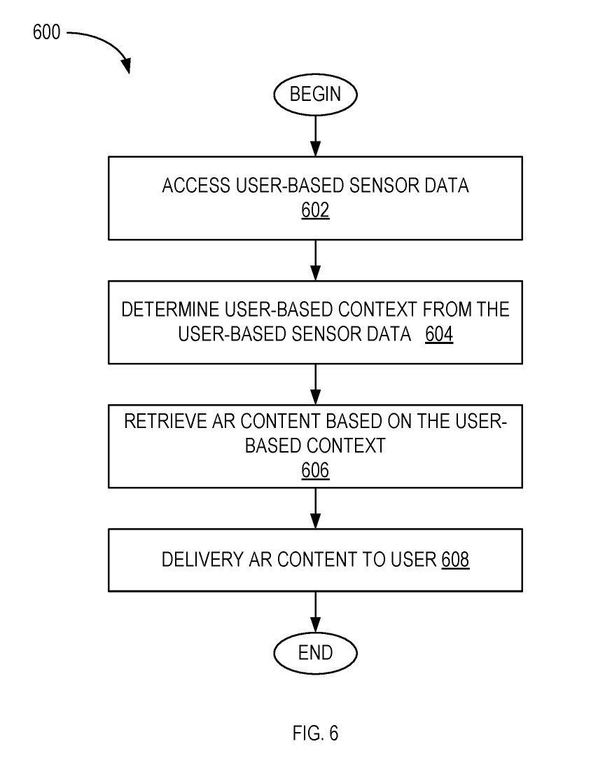

FIG. 4 is a block diagram illustrating an example embodiment of the context-based application 216. The context-based application 216 is shown by way of example to include a user-based context module 402 and an ambient-based context module 404. The user-based context module 402 determines a user-based context based on user-based sensor data related to the user 102. For example, the user-based context module 402 identifies user-based context “UC1” based on user-based sensor data matching attributes including user-based sensor data ranges defined in a library in the storage device 208 or in the server 110. The ambient-based context module 404 determines an ambient-based context based on ambient-based sensor data related to the HMD 101. For example, the ambient-based context module 404 identifies ambient-based context “AC1” based on ambient-based sensor data matching attributes including ambient-based sensor data ranges defined in a library in the storage device 208 or in the server 110.

The context-based application 216 may generate AR content based on a combination of the ambient-based context, the user-based context, and the identification of object A 116. For example, the context-based application 216 generates AR content “AR1” to the AR application 214 to display the AR content in the display 204 based on identifying a combination of ambient-based context AC1, user-based context UC1, and an identification of the physical object A 116. The context-based application 216 generates AR content “AR2” to the AR application 214 based on a second combination of ambient-based context AC1, user-based context UC1, and an identification of the physical object A 116.

In another example, the context-based application 216 generates AR application “AR App 1” for the AR application 214 based on identifying a combination of ambient-based context AC1, user-based context UC1, and identification of the physical object A 116. The context-based application 216 generates AR application “AR App 2” for the AR application 214 based on identifying a combination of ambient-based context AC2, user-based context UC2, and object identification of the physical object A 116. The context-based application 216 may generate an AR application by combining elements from existing AR applications to form a customized AR application based on a combination of the ambient-based context and the user-based context.

Any one or more of the modules described herein may be implemented using hardware (e.g., a processor 212 of a machine) or a combination of hardware and software. For example, any module described herein may configure a processor 212 to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

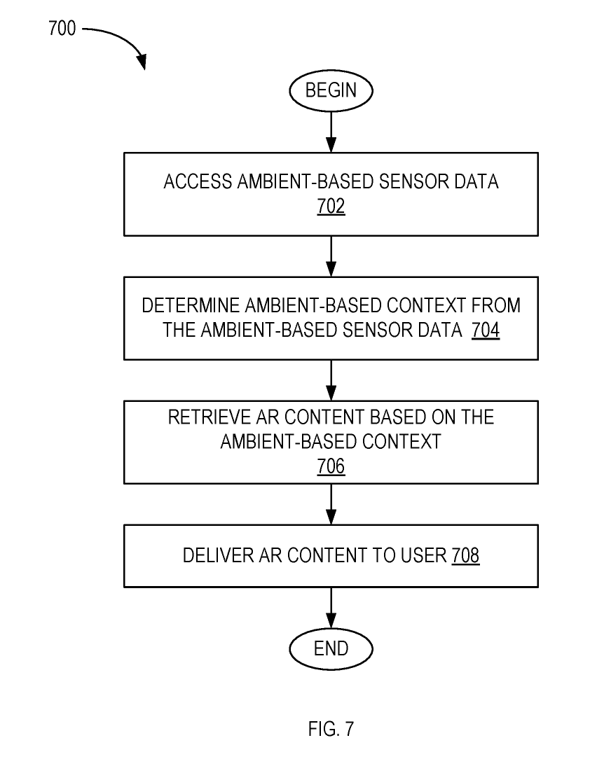

FIG. 5 is a block diagram illustrating modules (e.g., components) of the server 110. The server 110 includes an HMD interface 501, a processor 502, and a database 508. The HMD interface 501 may communicate with the HMD 101, and sensors 112 (FIG. 1) to receive real time data.

The processor 502 may include a server AR application 504. The server AR application 504 identifies real world physical objects A 116, B 118 based on a picture or image frame received from the HMD 101. In another example, the HMD 101 has already identified objects A 116, B 118 and provides the identification information to the server AR application 504. In another example embodiment, the server AR application 504 may determine the physical characteristics associated with the real world physical objects A 116, B 118. For example, if the real world physical object A 116 is a gauge, the physical characteristics may include functions associated with the gauge, location of the gauge, reading of the gauge, other devices connected to the gauge, safety thresholds or parameters for the gauge. AR content may be generated based on the real world physical object A 116 identified and a status of the real world physical object A 116.

The server AR application 504 receives an identification of user-based context and ambient-based context from the HMD 101. In another example embodiment, the server AR application 504 receives user-based sensor data and ambient-based sensor data from the HMD 101. The server AR application 504 may compare the user-based context and ambient-based context received from the HMD 101 with user-based and ambient-based context in the database 508 to identify a corresponding AR content or AR application. Similarly, the server AR application 504 may compare the user-based sensor data and ambient-based sensor data from the HMD 101 with the user-based sensor data library and ambient-based sensor data library in the database 508 to identify a corresponding AR content or AR application.

If the server AR application 504 finds a match with user-based and ambient-based context in the database 508, the server AR application 504 retrieves the AR content or application corresponding to the matched biometric data and provides the AR content or application to the HMD 101. In another example, the server AR application 504 communicates the identified AR content to the HMD 101.

The database 508 may store an object dataset 510 and a context-based dataset 512. The object dataset 510 may include a primary content dataset and a contextual content dataset. The primary content dataset comprises a first set of images and corresponding virtual object models. The contextual content dataset may include a second set of images and corresponding virtual object models. The context-based dataset 512 includes a library of user-based and ambient-based context with an identification of the corresponding ranges for the user-based sensor data and ambient-based sensor data in the object dataset 510.

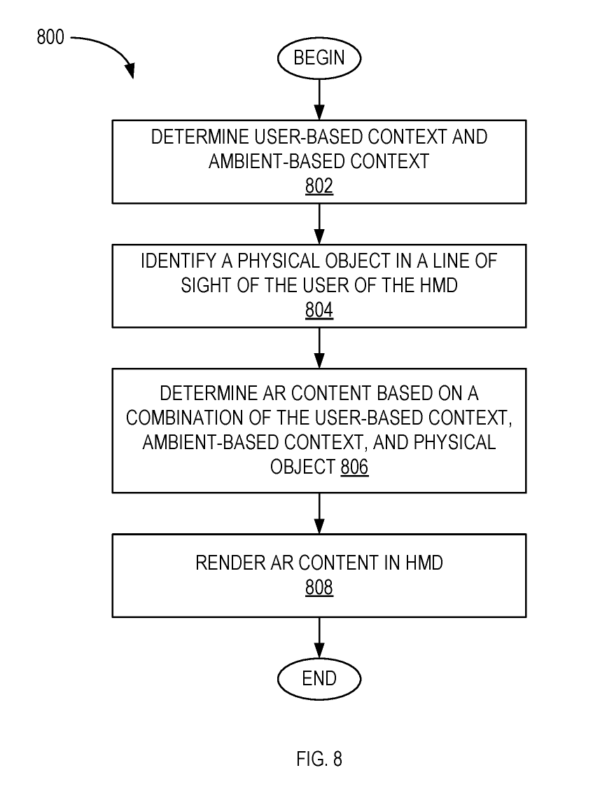

FIG. 6 is a flowchart illustrating a method 600 for delivering context-based augmented reality content, according to an example embodiment. The method 600 may be deployed on the HMD 101 and, accordingly, is described merely by way of example with reference thereto. At operation 602, the HMD 101 accesses user-based sensor data with the sensors 202. The HMD 101 may determine user-based sensor data on a periodic basis (e.g., every hour) or based on a predefined trigger (e.g., triggered by data from the sensors exceeding a predefined threshold). For example, the HMD 101 accesses the user-based sensor data when the user 102 puts on the HMD 101 or when the user 102 wearing the HMD 101 identifies a physical object in the line of sight of the user 102. In another example, the HMD 101 accesses the user-based sensor data in response to determining that the user is attempting to access AR content that is restricted to specific personnel of an organization. In another example, the HMD 101 accesses the user-based sensor data process when the location of the HMD 101 is associated with a geographic boundary that specifies the user 102 be authenticated prior to providing physical access (e.g., unlocking a door) or prior to providing AR content related to the geographic boundary. Operation 602 may be implemented using the user-based context module 402.

At operation 604, the HMD 101 determines a user-based context based on the user-based sensor data obtained at operation 602. For example, the user-based context module 402 compares the user-based sensor data with a library of user-based sensor data ranges to identify a corresponding user-based context. For example, a user-based context “UC1” may be based on predefined user-based sensor data ranges (e.g., user=John, mental state=alert, heartbeat=between 90 and 100 bpm). The library of user-based sensor data ranges may be locally stored in the storage device 208 or in a remote server such as server 110.

At operation 606, the HMD 101 retrieves, accesses, generates AR content based on the user-based context identified in operation 604. For example, the AR content may include virtual objects based on the user-based context UC1. The virtual objects may include virtual arrows, numbers, letters, symbols, and animated two-dimensional or three-dimensional models displayed in the display 204. For example, the HMD 101 renders a virtual checklist in the display 204 in response to detecting user-based context UC1. In another example, the HMD 101 renders the AR content based on the user-based context and an identified object in the line of sight of the user. For example, the HMD 101 renders a three-dimensional image/model of a specific screwdriver in the display 204 in response to detecting user-based context UC1 and object A 116. In another example embodiment, the HMD 101 retrieves a specific AR application associated with the user-based context identified in operation 604 from a library of AR applications in storage device 208. For example, the HMD 101 retrieves an AR application for repairing object A 116 in response to detecting user-based context UC1 and object A 116.

At operation 608, the HMD 101 delivers the AR content to the user 102 by rendering the AR content retrieved at operation 604 in the display 204. In another example embodiment, the HMD 101 runs the specific AR application retrieved at operation 604. Operation 608 may be implemented with AR application 214.

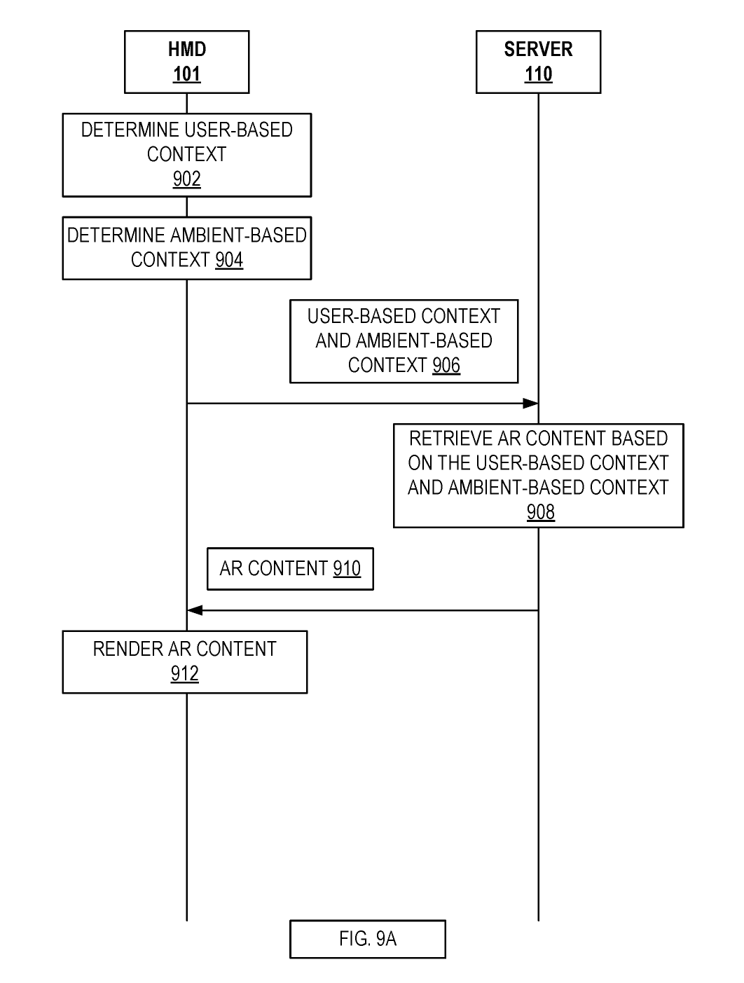

FIG. 7 is a flowchart illustrating a method 700 for delivering context-based augmented reality content, according to an example embodiment. The method 700 may be deployed on the HMD 101 and, accordingly, is described merely by way of example with reference thereto. At operation 702, the HMD 101 accesses ambient-based sensor data with the sensors 202. The HMD 101 may determine ambient-based sensor data on a periodic basis (e.g., every minute) or based on a predefined trigger (e.g., triggered by data from a combination of sensors 112 and 202 exceeding a predefined threshold). For example, the HMD 101 accesses the ambient-based sensor data when the user 102 puts on the HMD 101 or when the user 102 wearing the HMD 101 identifies a physical object in the line of sight of the user 102. In another example, the HMD 101 accesses the ambient-based sensor data in response to determining that the user is attempting to access AR content that is restricted to specific personal of an organization. In another example, the HMD 101 accesses the ambient-based sensor data process when the location of the HMD 101 is associated with a geographic boundary that specifies the user be authenticated prior to providing physical access (e.g., unlocking a door) or when one of the sensors 112 exceeds a predefined threshold (e.g., a malfunction detected by the temperature of the object A 116 exceeding a safe threshold). Operation 702 may be implemented using the ambient-based context module 404.

At operation 704, the HMD 101 determines an ambient-based context based on the ambient-based sensor data obtained at operation 702. For example, the ambient-based context module 404 compares the ambient-based sensor data with a library of ambient-based sensor data ranges to identify a corresponding ambient-based context. For example, an ambient-based context “AC1” may be based on predefined ambient-based sensor data ranges (e.g., object temperature>100° F., location of HMD=2^{nd} floor to 5^{th} floor of building B, humidity level<40%). The library of ambient-based sensor data ranges may be locally stored in the storage device 208 or in a remote server such as server 110.

At operation 706, the HMD 101 retrieves, accesses, or generates AR content based on the ambient-based context identified in operation 704. For example, the AR content may include virtual objects based on the ambient-based context AC1. The virtual objects may include virtual arrows, numbers, letters, symbols, and animated two-dimensional or three-dimensional models displayed in the display 204. For example, the HMD 101 renders a virtual checklist in the display 204 in response to detecting ambient-based context AC1. In another example, the HMD 101 renders the AR content based on the ambient-based context and an identified object in the line of sight of the user. For example, the HMD 101 renders a three-dimensional image of a specific screwdriver in the display 204 in response to detecting ambient-based context AC1 and object A 116. In another example embodiment, the HMD 101 retrieves a specific AR application associated with the ambient-based context identified in operation 704 from a library of AR applications in storage device 208. For example, the HMD 101 retrieves an AR application for repairing object A 116 in response to detecting ambient-based context UC1 and object A 116.

At operation 708, the HMD 101 delivers the AR content to the user 102 by rendering the AR content retrieved at operation 706 in the display 204. In another example embodiment, the HMD 101 runs the specific AR application retrieved at operation 704. Operation 708 may be implemented with AR application 214.

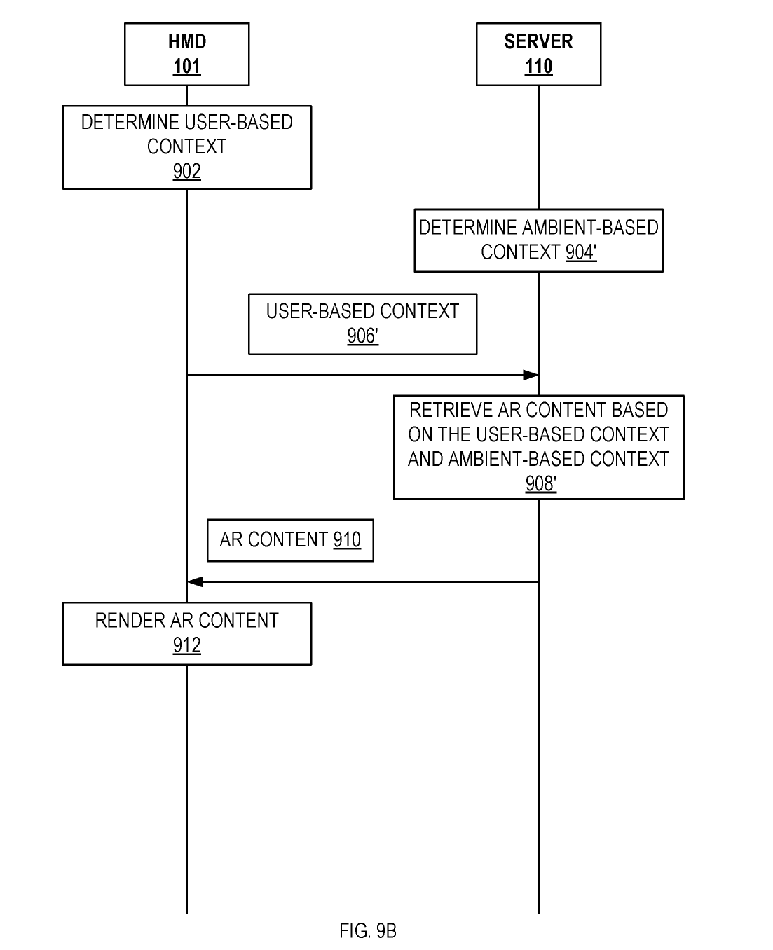

FIG. 8 is a flowchart illustrating a method 800 for delivering context-based augmented reality content, according to yet another example embodiment. The method 800 may be deployed on the HMD 101 and, accordingly, is described merely by way of example with reference thereto. At operation 802, the HMD 101 accesses both user-based sensor data and ambient-based sensor data with the sensors 202 (and optionally sensors 112). The HMD 101 may determine the user-based sensor data and the ambient-based sensor data on a periodic basis or based on a predefined trigger as previously described. Operation 802 may be implemented using the user-based context module 402 and the ambient-based context module 404.

At operation 804, the HMD 101 identifies a physical object in the line of sight of the user 102 of the HMD 101. For example, the HMD 101 identifies physical object A 116 when the user 102 stares or look at the physical object A 116 through the display 204 of the HMD 101. The identification may be accomplished through machine-vision and object recognition techniques.

At operation 806, the HMD 101 retrieves, accesses, generates AR content based on a combination of the user-based context, ambient-based context, and the physical object A 116 identified in operation 804. For example, the AR content may include virtual objects corresponding to a combination of user-based context UC1, ambient-based context AC1, physical object A 116 identification. For example, the HMD 101 renders a virtual repair checklist in the display 204 in response to detecting the user-based context UC1, ambient-based context AC1, physical object A 116. In another example embodiment, the HMD 101 retrieves a specific AR application associated with the combination of user-based context UC1, ambient-based context AC1, and physical object A 116 identification from a library of AR applications in storage device 208 or in the server 110. For example, the HMD 101 retrieves an AR application for repairing object A 116 in response to detecting user-based context UC1 and object A 116.

At operation 808, the HMD 101 delivers the AR content to the user 102 by rendering the AR content retrieved at operation 806 in the display 204. In another example embodiment, the HMD 101 runs the specific AR application retrieved at operation 806. Operation 808 may be implemented with AR application 214.

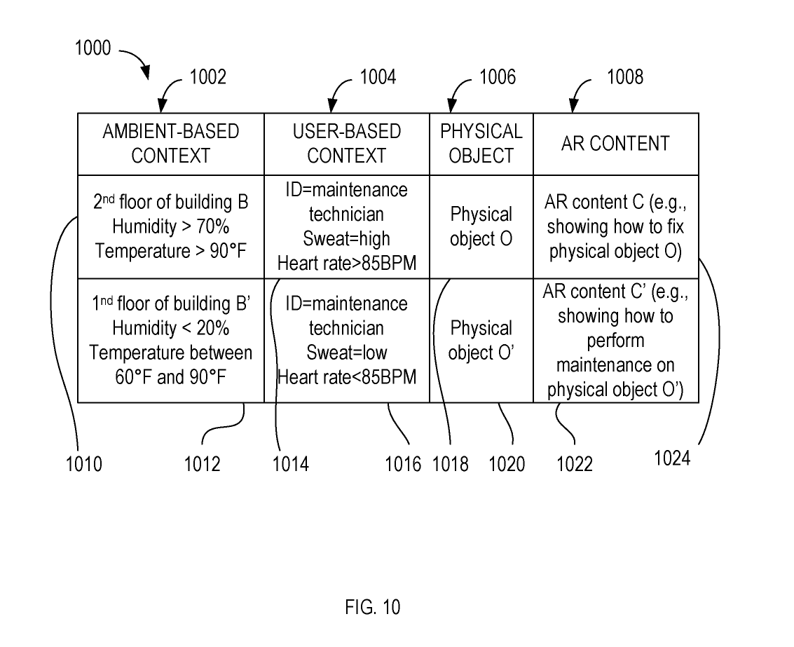

FIG. 9A is an interaction diagram illustrating interactions between a head mounted device (e.g., HMD 101) and a server (e.g., server 110) for context-based augmented reality content delivery, according to an example embodiment. The HMD 101 may communicate with the server 110 via the network 108. At operation 902, the HMD 101 determines the user-based context from user-based sensor data collected with sensors 202. Operation 902 may be implemented with the user-based context module 402 of the HMD 101. At operation 904, the HMD 101 determines the ambient-based context from ambient-based sensor data collected with sensors 202 and optionally with sensors external to the HMD 101 (e.g., sensors 112). Operation 904 may be implemented with the ambient-based context module 404 of the HMD 101.

In one example embodiment, the HMD 101 uploads the user-based context and the ambient-based context to the server 110 in operation 906 to retrieve a corresponding AR content associated with the user-based context and the ambient-based context. In another example embodiment, the HMD 101 uploads user-based sensor data and the ambient-based sensor data to the server 110 for the server 110 to determine the user-based context and ambient-based context. In yet another example embodiment, the HMD 101 uploads an identification of a physical object viewed by the user 102 wearing the HMD 101 in addition to the user-based context and the ambient-based context. In yet another example embodiment, the HMD 101 uploads a picture of a physical object in a line of sight of the user 102 wearing the HMD 101 in addition to the user-based context and the ambient-based context.

At operation 908, the server 110 searches for and retrieves an AR content or application based on the user-based context and ambient-based context received in operation 906. In another example embodiment, the server 110 determines the user-based context and ambient-based context based on user-based sensor data and the ambient-based sensor data received from the HMD 101. In yet another example embodiment, the server 110 determines identification of a physical object viewed by the user 102 wearing the HMD 101 based on an image of the physical object received from the HMD 101. In yet another example embodiment, the server 110 generates or identifies an AR content or an AR application from a library of AR content based on the user-based context, the ambient-based context, and the identification of the physical object. Operation 908 may be implemented by server AR application 504 of FIG. 5.

At operation 910, the server 110 provides the AR content or application to the HMD 101. The HMD 101 renders the AR content in the display 204 of the HMD 101 or runs the AR application as shown in operation 912. Operation 912 may be implemented with context-based application 216 and AR application 214.

FIG. 9B is an interaction diagram illustrating interactions between a head mounted device (e.g., HMD 101) and a server (e.g., server 110) for context-based augmented reality content delivery, according to an example embodiment. As previously described with respect to FIG. 9A, the HMD 101 may communicate with the server 110 via the network 108. At operation 902, the HMD 101 determines the user-based context from user-based sensor data collected with sensors 202. At operation 904′, the server 110 determines the ambient-based context from ambient-based sensor data collected with sensors external to the HMD 101 (e.g., sensors 112). Operation 904′ may be implemented with the server AR application 504 of the server 110.

In one example embodiment, the HMD 101 uploads the user-based context to the server 110 in operation 906′. In another example embodiment, the HMD 101 uploads user-based sensor data to the server 110 for the server 110 to determine the user-based context. In yet another example embodiment, the HMD 101 uploads an identification of a physical object viewed by the user 102 wearing the HMD 101 in addition to the user-based context. In yet another example embodiment, the HMD 101 uploads a picture of a physical object in a line of sight of the user 102 wearing the HMD 101 in addition to the user-based context.

At operation 908′, the server 110 searches for and retrieves an AR content or application based on the user-based context received in operation 906′. In another example embodiment, the server 110 determines the user-based context based on user-based sensor data received from the HMD 101. In yet another example embodiment, the server 110 determines identification of a physical object viewed by the user 102 wearing the HMD 101 based on an image of the physical object received from the HMD 101. In yet another example embodiment, the server 110 generates or identifies an AR content or an AR application from a library of AR content based on the user-based context, the ambient-based context, and the identification of the physical object. Operation 908′ may be implemented by server AR application 504 of FIG. 5.

At operation 910, the server 110 provides the AR content or application to the HMD 101. The HMD 101 renders the AR content in the display 204 of the HMD 101 or runs the AR application as shown in operation 912. Operation 912 may be implemented with context-based application 216 and AR application 214.

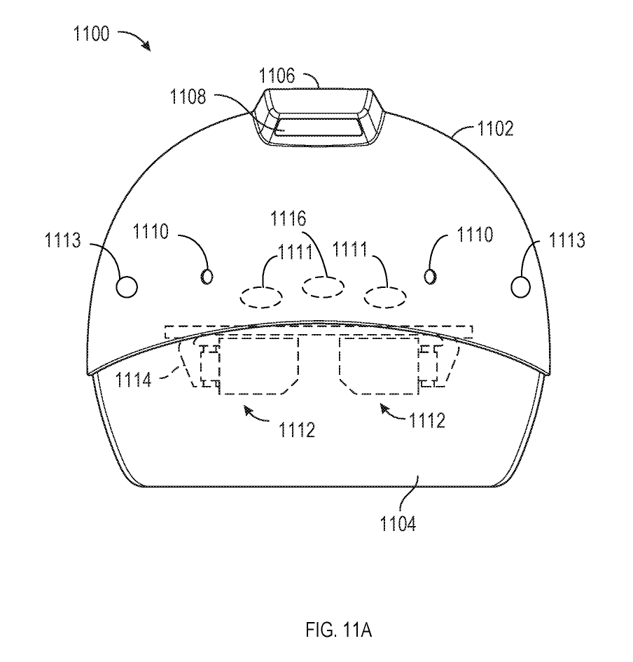

FIG. 10 is a block diagram illustrating an example of a library 1000 of context-based AR content, according to an example embodiment. The context may include an ambient-based context 1002 related to the HMD 101 and user-based context 1004 related to the user 102. The ambient-based context 1002 may be defined with preconfigured ranges of ambient-sensor data. For example, a first ambient-based context 1010 is defined when the HMD 101 is located on the second floor of building B, with a humidity level greater than 70% and a temperature of at least 90° F. A second ambient-based context 1012 is defined when the HMD 101 is located on the first floor of building B′, with a humidity level less than 20% and a temperature of between 60° F. and 90° F.

The user-based context 1004 may also be defined with preconfigured ranges of user-sensor data. For example, a first user-based context 1014 is defined when the user 102 of HMD 101 is identified as a maintenance technician, the sweat level of the user 102 is high, and the heart rate of the user is greater than 85 bpm. A second user-based context 1016 is defined when the user 102 of HMD 101 is identified as a maintenance technician, the sweat level of the user 102 is low, and the heart rate of the user 102 is less than 85 bpm.

The library 1000 may also identify physical objects 1006 associated with the ambient-based context 1002 and user-based context 1004. For example, physical object O may be associated with the ambient-based context 1010 and the user-based context 1014. Similarly, physical object O′ may be associated with the ambient-based context 1012 and user-based context 1016.

The library 1000 also identifies AR content 1008 associated with the ambient-based context 1002 and user-based context 1004. For example, AR content C 1024 (e.g., virtual animation showing how to fix physical object O) may be associated with the ambient-based context 1010, the user-based context 1014, and physical object O 1018. Similarly, AR content C′ 1022 (e.g., virtual animation showing how to perform maintenance on physical object O′) may be associated with the ambient-based context 1012, the user-based context 1016, and physical object O′ 1020.

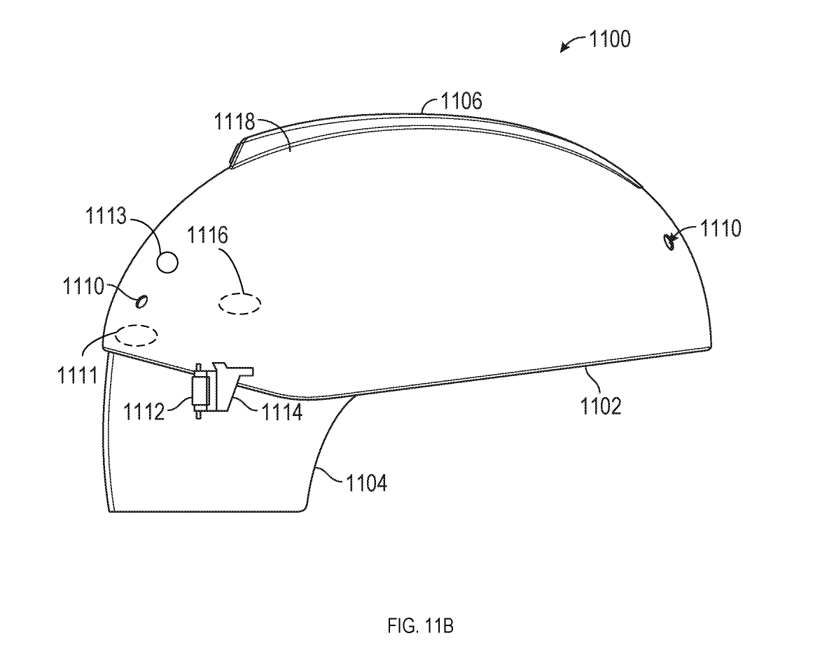

FIG. 11A is a block diagram illustrating a front view of a head mounted device 1100, according to some example embodiments. FIG. 11B is a block diagram illustrating a side view of the head mounted device 1100 of FIG. 11A. The HMD 1100 may be an example of HMD 101 of FIG. 1. The HMD 1100 includes a helmet 1102 with an attached visor 1104. The helmet 1102 may include sensors (e.g., optical and audio sensors 1108 and 1110 provided at the front, back, and a top section 1106 of the helmet 1102). Display lenses 1112 are mounted on a lens frame 1114. The display lenses 1112 include the display 204 of FIG. 2. The helmet 1102 further includes ocular cameras 1111. Each ocular camera 1111 is directed to an eye of the user 102 to capture an image of the iris or retina. Each ocular camera 1111 may be positioned on the helmet 1102 above each eye and facing a corresponding eye. The helmet 1102 also includes EEG/ECG sensors 1116 to measure brain activity and heart rate pattern of the user 102.

In another example embodiment, the helmet 1102 also includes lighting elements in the form of LED lights 1113 on each side of the helmet 1102. An intensity or brightness of the LED lights 1113 is adjusted based on the dimensions of the pupils of the user 102. The context-based application 216 may control lighting elements to adjust a size of the iris of the user 102. Therefore, the context-based application 216 may capture an image of the iris at different sizes for different virtual objects.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor 212 or a group of processors 212) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 212 or other programmable processor 212) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 212 configured using software, the general-purpose processor 212 may be configured as respective different hardware modules at different times. Software may accordingly configure a processor 212, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors 212 that are temporarily configured (e.g., by software) or permanently configured to perform the relevant operations. Whether temporarily or permanently configured, such processors 212 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 212 or processor-implemented modules. The performance of certain of the operations may be distributed among the one or more processors 212, not only residing within a single machine, but deployed across a number of machines. In some example embodiments, the processor or processors 212 may be located in a single location (e.g., within a home environment, an office environment or as a server farm), while in other embodiments the processors 212 may be distributed across a number of locations.

The one or more processors 212 may also operate to support performance of the relevant operations in a “cloud computing” environment or as a “software as a service” (SaaS). For example, at least some of the operations may be performed by a group of computers (as examples of machines including processors 212), these operations being accessible via a network 108 and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 212, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 108.

In example embodiments, operations may be performed by one or more programmable processors 212 executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers 110. A client and server 110 are generally remote from each other and typically interact through a communication network 108. The relationship of client and server 110 arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 212), or a combination of permanently and temporarily configured hardware may be a design choice. Below are set out hardware (e.g., machine) and software architectures that may be deployed, in various example embodiments.

### Example Machine Architecture

FIG. 12 is a block diagram of a machine in the example form of a computer system 1200 within which instructions 1224 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server 110 or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions 1224 (sequential or otherwise) that specify actions to be taken by that machine. Further, while only a single machine is illustrated, the term “machine” shall also be taken to include any collection of machines that individually or jointly execute a set (or multiple sets) of instructions 1224 to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a disk drive unit 1216, a signal generation device 1218 (e.g., a speaker) and a network interface device 1220.

### Machine-Readable Medium

The disk drive unit 1216 includes a computer-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media 1222. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers 110) that store the one or more instructions 1224 or data structures. The term “machine-readable medium” shall also be taken to include any tangible medium that is capable of storing, encoding or carrying instructions 1224 for execution by the machine and that cause the machine to perform any one or more of the methodologies of the present embodiments, or that is capable of storing, encoding or carrying data structures utilized by or associated with such instructions 1224. The term “machine-readable medium” shall accordingly be taken to include, but not be limited to, solid-state memories, and optical and magnetic media. Specific examples of machine-readable media 1222 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks 1226 include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions 1224 for execution by the machine, and includes digital or analog communications signals or other intangible media to facilitate communication of such software.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A head mounted device (HMD) comprising:
a transparent display;
a plurality of sensors including a first set of sensors configured to measure first sensor data related to a user of the HMD, and a second set of sensors configured to measure second sensor data related to the HMD;
a processor comprising an augmented reality (AR) application and a context-based application,
the context-based application being configured to determine a user-based context based on the first sensor data, to determine an ambient-based context based on the second sensor data, and to access AR content based on the user-based context and the ambient-based context; and
the AR application being configured to display the AR content on the transparent display.

2. The HMD of claim 1, wherein the context-based application is configured to:
identify an object depicted in an image generated by a camera of the HMD, the object located along a line of sight of the user through the transparent display; and
access the AR content based on an identification of the object.

3. The HMD of claim 1, wherein the first sensor data includes biometric data related to the user, the biometric data including at least one of a heart rate, a blood pressure, or brain activity,
wherein the second sensor data includes at least one of a geographic location of the HMD, an orientation and position of the HMD, an ambient pressure, an ambient humidity level, or an ambient light level.

4. The HMD of claim 1, wherein the context-based application is further configured to:
compare the first sensor data with reference sensor data; and
determine the user-based context based on the comparison of the first sensor data with the reference sensor data.

5. The HMD of claim 4, wherein the reference sensor data comprises a set of physiological data ranges for the user corresponding to the first set of sensors.

6. The HMD of claim 1, wherein the context-based application is further configured to:
compare the second sensor data with reference sensor data; and
determine the ambient-based context based on the comparison of the second sensor data with the reference sensor data.

7. The HMD of claim 6, wherein the reference sensor data comprises a set of ambient data ranges for the HMD corresponding to the second set of sensors.

8. The HMD of claim 1, wherein a first AR content is associated with a first set of physiological data ranges for the user of the HMD and a first set of ambient data ranges for the HMD,
wherein a second AR content is associated with a second set of physiological data ranges for the user of the HMD and a second set of ambient data ranges for the HMD.

9. The HMD of claim 1, wherein the processor further comprises a first AR application and a second AR application,
wherein the first AR application is associated with a first set of physiological data ranges for the user of the HMD and a first set of ambient data ranges for the HMD, and
wherein the second AR application is associated with a second set of physiological data ranges for the user of the HMD and a second set of ambient data ranges for the HMD.

10. The HMD of claim 1, wherein the context-based application is configured to:
receive third second sensor data from a third set of sensors located outside to the HMD,
the context-based application being further configured to determine the ambient-based context based on the second sensor data and third sensor data.

11. A method comprising:
measuring first sensor data related to a user of an HMD with a first set of sensors located in the HMD;
measuring second sensor data related to the HMD with a second set of sensors located in the HMD;
determining a user-based context based on the first sensor data;
determining an ambient-based context based on the second sensor data;
accessing AR content based on at least one of the user-based context and the ambient-based context; and
displaying, using a processor of the HMD, the AR content on a transparent display in the HMD.

12. The method of claim 11, further comprising:
identifying an object depicted in an image generated by a camera of the HMD, the object located along a line of sight of the user through the transparent display; and
accessing the AR content based on an identification of the object.

13. The method of claim 11, wherein the first sensor data includes biometric data related to the user, the biometric data including at least one of a heart rate, a blood pressure, or brain activity,
wherein the second sensor data includes at least one of a geographic location of the HMD, an orientation and position of the HMD, an ambient pressure, an ambient humidity level, or an ambient light level.

14. The method of claim 11, further comprising:
comparing the first sensor data with reference sensor data; and
determining the user-based context based on the comparison of the first sensor data with the reference sensor data.

15. The method of claim 14, wherein the reference sensor data comprises a set of physiological data ranges for the user corresponding to the first set of sensors.

16. The method of claim 11, further comprising:
comparing the second sensor data with reference sensor data; and
determining the ambient-based context based on the comparison of the second sensor data with the reference sensor data.

17. The method of claim 16, wherein the reference sensor data comprises a set of ambient data ranges for the HMD corresponding to the second set of sensors.

18. The method of claim 11, wherein a first AR content is associated with a first set of physiological data ranges for the user of the HMD and a first set of ambient data ranges for the HMD,
wherein a second AR content is associated with a second set of physiological data ranges for the user of the HMD and a second set of ambient data ranges for the HMD.

19. The method of claim 11, further comprising:
receiving third second sensor data from a third set of sensors located outside to the HMD; and
determining the ambient-based context based on the second sensor data and third sensor data.

20. A non-transitory machine-readable medium comprising instructions that, when executed by one or more processors of a machine, cause the machine to perform operations comprising:
measuring first sensor data related to a user of the machine with a first set of sensors located in the machine;
measuring second sensor data related to the machine with a second set of sensors located in the machine;
determining a user-based context based on the first sensor data;
determining an ambient-based context based on the second sensor data;
accessing AR content based on at least one of the user-based context and the ambient-based context; and
displaying the AR content on a transparent display of the machine.
